(19) United States
(12) Patent Application Publication
(10) Pub. No.: US 2006/0104568 A1
(43) Pub. Date: May 18, 2006

(54) Optically induced refractive index modification in ferroelectric optical

(76) Inventors: Robert William Eason, Hampshire (GB); Sakellaris Mailis, Hampshire (GB); Christos Riziotis, Hampshire (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/522,042

(22) PCT Filed: Jul. 21, 2003
(86) PCT No.: PCT/GB03/03242

§ 371 Date: Sep. 19, 2005

(30) Foreign Application Priority Data
Jul. 23, 2002 (GB) 0217047.0

(51) Int. Cl. G02B 6/34

(52) U.S. Cl. 385/37

(57) ABSTRACT

A method of inducing refractive index modifications in ferroelectric materials through the application of light in the form of scanned or patterned irradiation, removing the light to leave a permanent refractive index modified structure. This method can be used to design and engineer surface or near-surface structures in the form of waveguides, junctions, splitters and couplers, for application in optical circuitry, integrated optics, and active waveguide devices.

### BACKGROUND OF THE INVENTION

The present invention relates to refractive index modification in ferroelectic materials.

In a particular class of optical materials, ferroelectric single crystals such as lithium niobate (LiNbO₃) and lithium tantalate (LiTaO₃) have an increasingly widespread usage in the photonics industry due to their diverse range of nonlinear, piezoelectric, pyroelectric, electrooptic, photoelastic and photorefractive properties. Large quantities of high optical quality congruent (lithium deficient) and recently stochiometric lithium niobate single crystals are grown by many crystal companies for a variety of applications including integrated Mach-Zehnder optical modulators for telecommunications [1], surface acoustic wave (SAW) devices [2] and domain engineered periodically poled materials for efficient quasi-phase-matched nonlinear optical devices for harmonic and parametric wavelength conversion applications [3].

Many of these applications, for which the efficiency or speed depends on the product of interaction length and optical intensity, require the fabrication of (low loss) optical channel waveguides. Waveguide fabrication in these materials has been much researched in the past few decades, but the techniques that are currently most favoured within industry rely on multi-step, complicated and time-consuming processes, that require clean-rooms, high temperatures, and the use of undesirable and potentially harmful chemicals. For LiNbO₃ waveguide fabrication, the most widely used methods are: (a) Ti: indiffusion [4] and (b) proton exchange [5]. Whereas these methods are capable of producing low loss waveguides, they are all inherently multi-step and invariably require the sequential processes of photolithographic patterning or masking, involving many photoresist processing steps, diffusion at high temperature or immersion in ion or chemical exchange baths, surface cleaning, and final processing. All of these must be performed under clean-room conditions, and have a non-negligible implication for safety requirements and environmental issues. Additionally, in the case of proton exchange, for example, only M (transverse magnetic) modes can propagate within these guides, and there is an additional process step required for the restoration of the nonlinearity due to ion exchange induced damage of the material. The various waveguide fabrication techniques currently used with ferroelectric materials are hence complex, costly, time consuming, slow and inflexible.

Given the extensive desire for ferroelectric materials with waveguiding capabilities, an improved technique for waveguide fabrication would be of great benefit.

### SUMMARY OF THE INVENTION

Accordingly, the present invention is directed to a method of inducing a surface refractive index modification in ferroelectric material comprising: providing a sample of ferroelectric material; determining a desired pattern of surface refractive index modification to be induced in the sample; and exposing an area of the sample corresponding to the desired pattern to optical radiation to deliver a quantity of optical energy sufficient to induce a permanent surface refractive index modification in the exposed area of the sample.

The present invention thus provides an uncomplicated, one-step process that can be used to fabricate refractive index structures, that utilises a property of ferroelectric material that allows the surface refractive index to be changed by exposing the material to an appropriate amount of light The method has immediately attractive features, as it is extremely simple, does not require the use of clean-room is facilities, depositions of photoresist or other such materials, does not require the use of potentially toxic or hazardous chemicals, is highly controllable and adjustable, and can be used to write structures of specific size, shape, depth, width and length.

The character of the induced optical refractive index structure in relation to aspects such as its depth, widths numerical aperture, and other such optical properties is controllable through the duration, focussing, power density, scan speed and wavelength of the incident light source. The implementation of the technique is simple, direct, and a one-step process, in contrast to previous techniques that are inherently multi-step in nature, and usually require sequential steps involving photolithographic processing, and clean-room preparation conditions. Replacing these existing techniques with a radically simpler, more flexible, faster and cheaper single-step process is therefore highly beneficial Some advantages of the present invention can be conveniently summarised in the following table:

| | Proton exchange | Ti: indiffusion | Present Invention |
|---|---|---|---|
| Speed | Slow: hrs/days | Slow: hrs/days | Fast: minutes |
| Loss | Low | Low | Low |
| Steps | Multi | Multi | Single |
| Flexibility | Limited | Limited | High |
| Clean-room | Yes | Yes | No |
| required? | | | |

The method allows great flexibility in the fabrication of structures with desired characteristics. Therefore, preferably, the quantity of optical energy is selected to induce a surface refractive index modification of a desired magnitude. The quantity of optical energy may be determined by controlling one or more of intensity of the optical radiation, fluence of the optical radiation, duration of exposing the area of the sample, and absorption depth of the optical radiation in the sample. Varying these parameters allows a refractive index structure of a desired depth, width and strength to be written with ease.

Advantageously, the optical radiation has a sub-micron absorption depth in the sample. This is a convenient way of rapidly delivering a sufficient quantity of optical energy to the surface region of the sample. Further, the optical radiation may be of an ultraviolet wavelength, or a visible wavelength. Thus, the wavelength may be chosen having regard to the absorption properties of the sample material.

In one embodiment, exposing an area of the sample comprises directing a focussed beam of optical radiation onto the sample. This increases the intensity so that delivery of the optical energy is more efficient. Use of a beam of radiation also allows the exposure to be performed using a “writing” technique, so that channels of modified index can be produced. So, in some embodiments, exposing an area of the sample further comprises causing relative movement between the sample and the beam of optical radiation.

A longer exposure time tends to result in a larger area of index modification, so that different speeds of relative movement can be used to write channels of different widths. Consequently, the relative movement may be of a constant speed, so as to give a channel of constant width, or of a varying speed, to give a channel of varying width.

Further, the beam of optical radiation may contain fringes of high and low intensity to induce a refractive index modification having the form of an optical grating.

As an alternative to writing the desired pattern using a beam of light, a more extensive area can be exposed at one time by using a mask to define the desired pattern. Therefore, exposing an area of the sample may comprise projecting the optical radiation through a mask and onto the sample. The mask may include one or more regions configured to project fringes of high and low intensity optical radiation onto the sample to induce a refractive index modification having the form of an optical grating.

The versatility of the method can be seen in its ability to produce virtually any pattern of index modification, so that a wide range of different optical structures can be fabricated. For example, the desired pattern of surface refractive index modification may comprise a line so that the induced permanent refractive index modification comprises a channel waveguide. Additionally, the desired pattern of surface refractive index modification may comprise a network of lines so that the induced permanent refractive index modification comprises a network of channel waveguides. Alternatively, the desired pattern of surface refractive index modification may comprise a continuous region so that the induced permanent refractive index modification comprises a planar waveguide.

The sample of ferroelectric material may comprise one or more dopants. These can perform any of several functions, to improve or modify the fabrication process and the final product For example, the one or more dopants might comprise optically active ions that allow a waveguide formed in the sample to exhibit laser or amplifying action. Also, the one or more dopants may increase absorption of the optical radiation by the sample; this improves the efficiency of the exposure of the sample. Ferroelectric materials are prone to photorefractive damage; this can be addressed in the present case by using one or more dopants which reduce susceptibility of the sample to photorefractive damage caused by exposure to the optical radiation.

To increase the range of optical devices that can be produced using the present invention, the method may be applied to a sample of ferroelectric material having a domain-engineered structure. Preferably, the sample is periodically poled. This allows waveguiding structures produced by the method to be used, for example, for quasi-phasematched interactions for parametric applications.

In an advantageous embodiment, the sample comprises a pre-existing structure of altered refractive index, and the desired pattern of surface refractive index modification is determined to modify the pre existing structure. This can be considered as “trimming”, in which a later processing step is applied to refine and tidy a previously fabricated refractive index structure. The present invention is well-suited to this, since various embodiments allow very precise index modification.

As an example, the present invention may be considered to be a method of inducing a localised change in refractive index in a sample of ferroelectric material, comprising: applying a light source of sufficiently high intensity to the surface of the material, to define the desired position for induced refractive index change; scanning the relative positions of the incident light source and the material to be irradiated (this can involve a stationary material and scanned light source, or stationary light source and scanned material, or a combination of the two); and removing the presence of the light source, to leave the material with a modified refractive index pattern on or near the surface of the material. The choice of light fluence, scanning speed and spot size or the illumination source may be optimist. The light source is a laser source of a wavelength that will be efficiently absorbed at or near the material surface, for example a continuous wave UV (ultraviolet) laser light source, at or near a wavelength below the value of 350 nm that possesses an optimum beam quality, thereby enabling tight focussing of the irradiating light. The ferroelectric material is one of lithium niobate, lithium tantalate, KTiOPO₄, RTiOAsO₄, RTiOPO₄, BaTiO₃, KNbO₃, or any other suitable mixed solid solution host such as the SrₓBa₁₋ₓNbO₃ family of tungsten bronze crystals.

The method might be directed towards the fabrication of an optical waveguide layer within the surface region of the crystal. A ratter scan of the light source across the sample surface, or a scan of the surface beneath the stationary light source, or alternatively a combination of these two methods will lead to a surface area which has been modified in its refractive index. This layer may be referred to as a planar waveguide layer.

Alternatively, the method might be directed towards the fabrication of an optical waveguide channel within the surface region of the crystal. A raster scan of the light source across the sample surface, or a scan of the surface beneath the stationary light source, or alternatively a combination of these two methods will lead to a surface area which has been modified in its refractive index. This layer may be referred to as a channel waveguide layer.

As a further alternative, the method can be directed towards the fabrication of more complex two dimensional optical circuitry written into or near to the surface region of the ferroelectric material. Pathways within the surface region comprising channels, junctions, overlaps, crossings, splitters, adjacent element with spaces between, and so forth can be written using the technique.

Variations of the method allow the writing of gratings, or other periodic structures, either by direct write and scanning, or else by the use of a diffractive or otherwise interferometric patterning technique, such as the use of a phase mask, or alternative amplitude or phase grating. Any such structure can have arbitrarily complex spatial patterning into or near to the surface of the ferroelectric material.

Also, it is possible to imprint a structure into or near the surface of the ferroelectric material by contact printing, or otherwise by projection reproduction, using a technique other than by serial scanning of the light source or material to be irradiated, or combinations of these two techniques. Scanning techniques can be used to trim or modify or otherwise alter existing refractive index structures for designer based optical circuitry requirements.

In a further example, the method may be described as a method for modifying the refractive index of optical materials through the interaction of light with the material structure, comprising: illumination of the material with light at a sufficiently high power density, scanning of the material or illuminating light source to form a two dimensional pattern or structure; and removing the light source to leave a permanently affected area on the sample surface. The material under illumination is a ferroelectric host, and the illuminating light source can be a laser beam with a wavelength in the visible, near UV or UV spectral regions. If in the UV the wavelength can be near to the bandgap of the material, or beyond the bandgap of the material. The power density of the light source is sufficient to induce the required refractive index modification. The light source can be scanned over the sample surface, or the light source can be stationary and the sample scanned, or the light source and the sample surface can be moved relative to one another. Further, the sample can be illuminated by a mask, or pattern in a parallel illumination fashion.

The sample can be doped, such as with elements to reduce the photorefractive damage in ferroelectic materials, with atoms or ions to promote active device structures, and/or with atoms or ions to promote lasing or amplifying within the host material. Moreover, the sample can be in the form of a single domain structure or a multi-domain structure, and it may be in the form of a periodically poled or otherwise domain engineered structure.

### BRIEF DESCRIPTION OF THE DRAWINGS

For a better understanding of the invention and to show how the same may be carried into effect reference is now made by way of example to the accompanying drawings in which.

FIG. 1 shows a schematic representation of apparatus for scanning a source of UV light across the surface of a sample of ferroelectric material whose refractive index is to be modified according to an embodiment of the present invention;

FIG. 2 shows a schematic representation of apparatus for scanning a source of UV light across the surface of a sample of ferroelectric material whose refractive index is to be modified according to a fierier embodiment of the present invention;

FIG. 3 shows a first example of a profile of a guided-wave near field two-dimensional beam profile written according to an embodiment of the present invention;

FIG. 4 shows a second example of a profile of a guided-wave near field two-dimensional beam profile written according to an embodiment of the present invention;

FIG. 5(a) shows a third example of a profile of a guided-wave near field two-dimensional beam profile written according to an embodiment of the present invention;

FIG. 5(b) shows a fourth example of a profile of a guided-wave near field two-dimensional beam profile written according to an embodiment of the present invention;

FIG. 6 shows a fifth example of a profile of a guided-wave near field two-dimensional beam profile written according to an embodiment of the present invention; and

FIG. 7 shows a sixth example of a profile of a guide-wave near field two-dimensional beam profile written according to an embodiment of the present invention.

### DETAILED DESCRIPTION

The present invention is based on the recognition from experimental evidence that there is an interaction between incident light and the surface of ferroelectric materials, such as lithium niobate (LiNbO₃), that causes a change in the refractive index of the material such that waveguiding tracks and other refractive index structures can be written by simple illumination of the surface. For example, a laser beam can be scanned across the material, or alternatively, the material can be scanned beneath a stationary laser beam, or a combination of both.

For the correct fluence of incident light the surface of the material is not damaged to any appreciable or noticeable degree, but the absorbed light affects the material properties, thereby leaving a permanent change to the irradiated material. The refractive index is increased in this region, leading to the formation of a track whose width is a function of the width of the incident laser beam. Once the incident light is removed, this permanent change results in an optical waveguide structure, thereby providing a means for direct writing to a specific position on the surface of the ferroelectic material. Other refractive index patterns may be written by exposing an appropriate area of the material. Therefore, to achieve a particular refractive index structure, the pattern or outline shape of the desired refractive index modification is determined, and an area on the surface of the material corresponding to that pattern is exposed to the incident light.

Apparatus

Any convenient technique for exposing the surface of the ferroelectric material to optical radiation may be used, with the requirement that a sufficient quantity of optical energy is delivered to induce the effect, and that an area of the material can be exposed that corresponds to the desired pattern of refractive index change.

FIG. 1 shows a schematic representation of apparatus suitable for implementing an embodiment of the invention. In this example, the optical energy is provided as a beam of laser light directed onto the surface of the ferroelectric material. Therefore, the apparatus comprises an optical source 10 in the form of a laser operable to generate a beam of light. The optical power delivered to the ferroelectric material has an effect on the induced change in refractive index, as will be discussed in more detail later, so the output beam 11 of the laser 10 is passed through a power control system 12 such as an acousto-optic modulator or a variable attenuator so that the power can be modified as required. Also, the power control system 12 ensures temporal stability of the laser output, which is a common requirement in laser writing processes. A series of mirrors 14 is arranged after the power control system 12 that direct the beam 11 to a desired delivery location. A lens 18 focuses the beam 11 to give a spot of light of a desired intensity and size. The lens 18 can be moved along the axis of the beam (as indicated by the arrow Z) to provide adjustable focussing so that the spot size may be varied.

A sample of ferroelectric material 16 is positioned at the delivery location, and mounted on a translation stage 20. The stage 20 is configured to translate the sample 16 with respect to the beam 11 in the X and Y directions, and is preferably under computer control so that precise positioning can be achieved. Additionally, movement in the Z direction can be provided via the stage 20 which may replace or supplement the Z direction adjustability of the lens 18.

In operation, the focussed beam 11 is directed onto the surface of the sample 16. The stage 20 then moves or scans the sample 16 so that the incident spot of light traces out a desired pattern of refractive index modification across the surface of the sample. Provided the optical energy is sufficient, the refractive index will be altered in all regions exposed to the radiation. In this way, a line or network of lines of modified refractive index can be “written” across the sample surface, the lines having a width related to the size of the light spot. The lines can operate as channel waveguides. Thus, by appropriate relative movement, a simple or complex waveguide structure comprising straight and/or curved sections can be formed, with a width that can be varied by altering the position of the focussing lens 18.

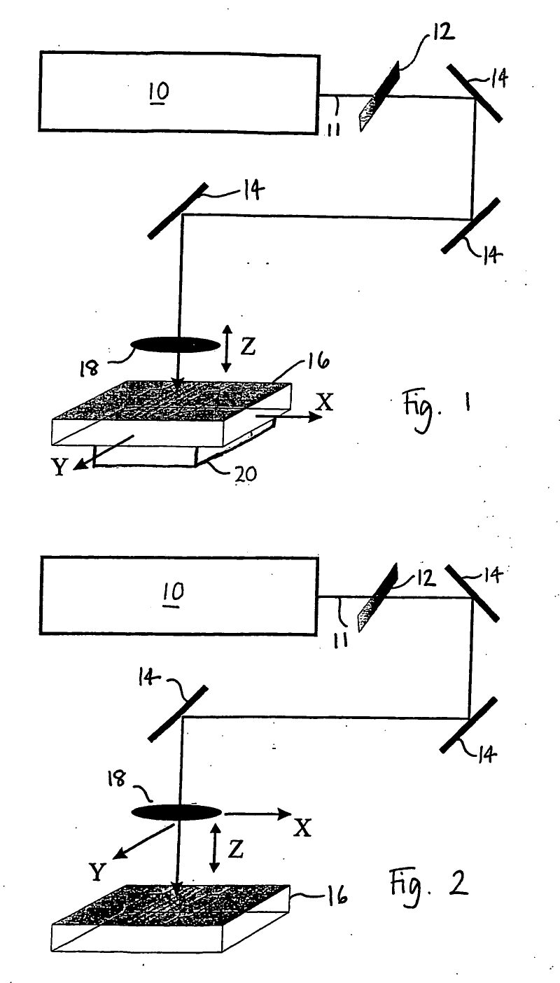

An equivalent effect may be achieved in an embodiment in which it is the light source or beam that is scanned, while the sample is stationary. The beam may be scanned through the use of controllable deflection devices such as mirrors, or other addressable devices such as beam deflectors, acousto-optic modulators, liquid crystal scanners, or other such devices. FIG. 2 shows a schematic representation of example apparatus for implementing this embodiment. The apparatus is substantially the same as that shown in FIG. 1 (with like parts labelled with like reference numerals), but the translation stage 20 of FIG. 1 is replaced by a beam deflection device (not shown) operable to deflect the beam in directions orthogonal to its propagation direction so that the beam can be scanned in the X and Y directions over the surface of the sample.

Alternatively, the beam and the sample can both be scanned, either simultaneously or sequentially. This may permit more complex refractive index patterns to be fabricated, depending on the flexibility of the scanning equipment used.

A focussed beam is particularly applicable to the fabrication of channel waveguides since elongate structures may conveniently be written with a single pass of the beam. However, planar waveguide structures may also be fabricated using a single focussed beam, by scanning the sample and/or the beam in a raster configuration so as to expose a continuous and extensive region of the sample.

Use of a focussed beam is not essential. Instead, a divergent or parallel beam of light may be used, which will expose a greater area at one time, and potentially reduce the need for relative movement. Further, the desired refractive index pattern may be exposed onto the sample surface by directing the light through a mask, in a fashion similar to that used for photolithography exposure. The mask may be in contact with the surface of the sample, or positioned between the sample and the light source. Known mask fabrication techniques can be used to generate a wide variety of exposure patterns corresponding to a wide variety of modified refractive index structures.

Further, the technique may be used to fabricate surface grating structures by using optical radiation with a fringe pattern, using fringe generation techniques commonly used to write gratings in optical fibres. The techniques include two beam interference, and exposure through a suitable mask. The fringe pattern comprises a series of lines of high and low optical intensity, so that exposure of the ferroelectric with such a pattern will produce a refractive index change in the areas of high intensity and little or no change in the areas of low intensity. The result is a grating comprising lines of alternating high and low index. Exposure can be increased and susceptibility to localised fluctuations in the fringe pattern reduced by causing stepwise relative movement between the fringe pattern and the sample so that each grating line is formed from successive exposure to a different high intensity fringe.

Experimental Results

The present technique of direct writing of refractive index changes into ferroelectric materials has been applied to congruent lithium niobate single crystals in the first instance. The results of this process have shown that exposure of undoped lithium niobate single crystals to ultraviolet (UV) radiation under a range of conditions can locally change the refractive index of the irradiated area. It has additionally been seen that the refractive index can be raised under specified conditions of irradiation. For the results seen, the crystal sample was scanned under a stationary light source, which in this example was a continuous wave UV laser source, as shown in FIG. 1. For a focussed UV laser beam, at irradiances of order 0.5 MW cm⁻², an optical guiding structure was created that corresponds to a channel waveguide.

In this example, the light source 10 was a frequency doubled continuous wave Ar⁺ (Argon ion) laser operating at 244 nm and an x-y-z computer controlled high precision translation stage 20 was used to write controllable channel waveguides of adjustable depth, width and refractive index values.

Under a range of irradiation conditions, these refractive index channels act as optical waveguides, also of variable width, depth, numerical aperture and induced values of modified refractive index.

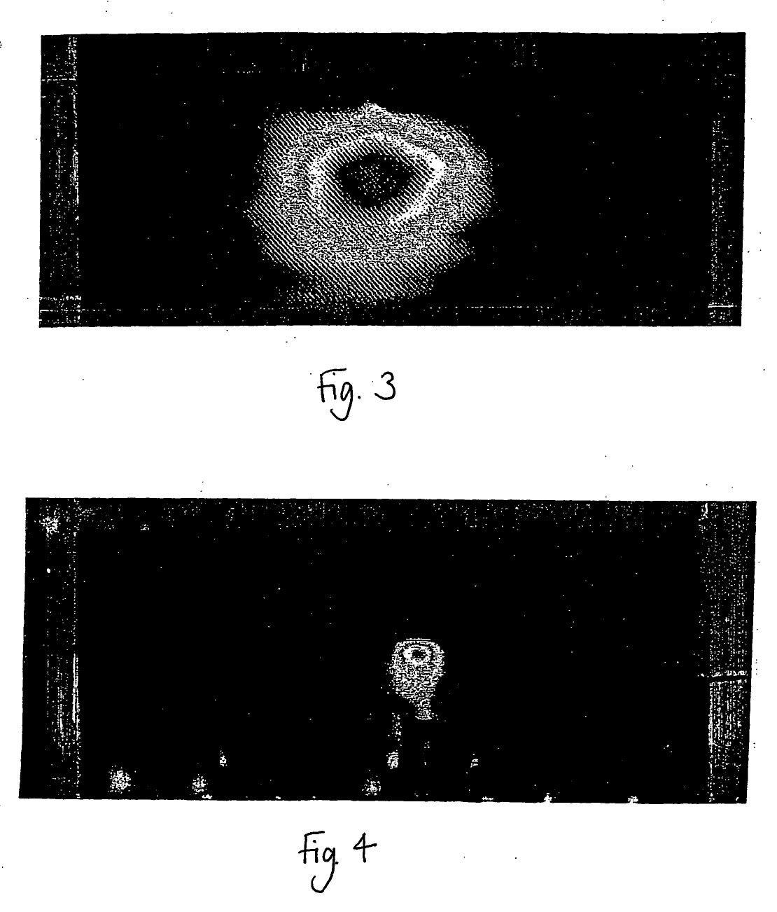

FIG. 3 shows an example optical mode profile of a guided wave structure written in this example by the method illustrated in FIG. 1. The mode profile illustrated is of a guided wave beam from a HeNe laser at a wavelength of 633 nm, in a waveguide written under a regime of comparatively low irradiation fluence. It is seen that the profile is relatively extended, indicating that the induced index change is moderate.

FIG. 4 shows a further example optical mode profile of a guided wave structure written in this example by the method illustrated in FIG. 1. The mode profile illustrated is of a guided wave beam from a HeNe laser at a wavelength of 633 nm, in a waveguide written under a regime of comparatively high (and higher than that of FIG. 3) irradiation fluence. It is seen that the profile is much less extended than that of FIG. 3, indicating that the induced index change is higher than that of FIG. 3.

These example channels are optical waveguiding structures that are capable of guiding both TE (transverse electric) and TM (transverse magnetic) modes. This should be contrasted with the prior art technique of proton exchange, which gives TM mode guiding waveguides only. Numerical apertures (NA) for single mode waveguides at 633 nm of order NA=0.05 have been measured, which corresponds to an induced refractive index change of order Δn˜10⁻³.

Further results have been obtained again using a frequency-doubled Ar⁺ laser (244 nm) as a source of UV optical radiation. Translation of the ferroelectric sample was achieved using a set of computer controlled, high precision x-y translation stages to scan the sample under a focussed beam of light from the laser. The translation stages allowed movement of 20 cm in each direction with a 50 nm positioning accuracy at speeds up to 5 cm/sec.

Samples of ferroelectric material were diced out of z-cut and y-cut LiNbO₃ wafers. Exposure of the samples was performing using a range of laser energy fluence and laser intensity between 20 J/cm² and 9500 J/cm² and between 60 kW/cm² and 600 kW/cm² respectively. These ranges were achieved by combinations of translation stage velocity, laser power and laser beam spot size. The range of translation stage velocities was between 0.017 cm/sec and 1.33 cm/sec, the laser power varied between 20 mW and 60 mW, and two different spot sizes, 1.75 μm and 3.25 μm, were used.

Channel waveguides were written into the samples under these various regimes, and optical characterisation of the waveguides was performed by launching visible (HeNe 633 nm) and infrared (HeNe 1523 nm) optical radiation into the waveguides. Near field optical mode profiles were obtained by imaging the waveguide outputs.

TM waveguide modes were excited in waveguides written on z-cut samples, and TE modes in y-cut samples. This suggests a induced refractive index modification that is a change of the extraordinary refractive index of the sample material. From the mode profiles, the mode confinement in the waveguides was found to be a function of the laser fluence and laser intensity used to write the waveguides, which offers control of the guiding conditions and the waveguide propagation mode characteristics by manipulation of these parameters.

FIGS. 5(a) and 5(b) show two near field waveguide mode profiles at 633 nm obtained from two different waveguides fabricated using different exposure conditions. The waveguide corresponding to the single mode profile in FIG. 5(a) was written using a 1.75 μm writing beam spot size at a laser fluence of 85 J/cm² while the waveguide corresponding to the higher order mode profile in FIG. 5(b) was written with a 3.25 μm spot size at an energy fluence of 70 J/cm². The horizontal width of the mode profiles shown in FIGS. 5(a) and 5(b) corresponds roughly to the width of the exposed area (3.5 μm and 6.5 μm respectively).

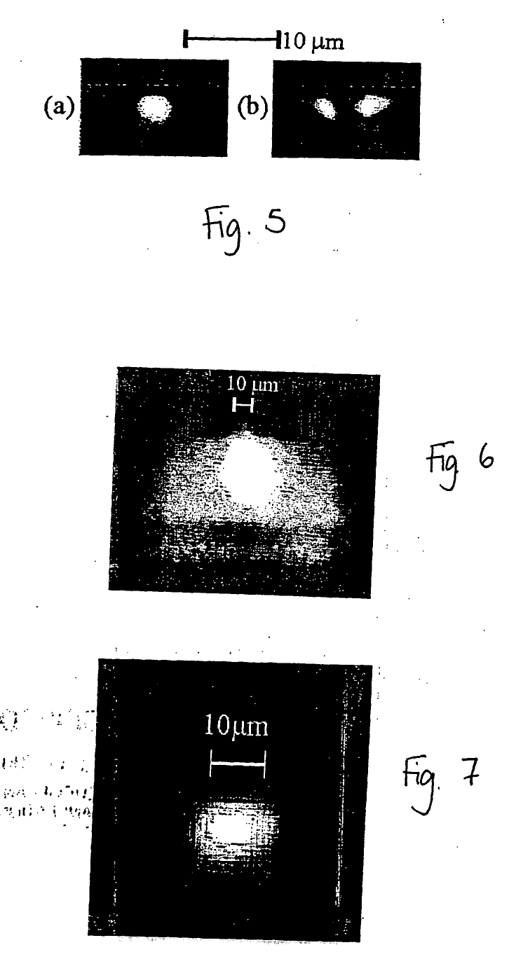

FIG. 6 shows a further mode profile from a waveguide written with a 3.25 μm spot size at a energy fluence of 70 J/cm², this time for transmission at 1523 nm. The mode confinement is less than for transmission at 633 nm due to weaker guiding conditions for the particular combination of refractive index change and width of the illuminated channel used. As shown in FIG. 6 the mode profile spreads far beyond the width of the exposed area which is ˜6.5 μm.

FIG. 7 shows another near-field mode profile from a TV-written waveguide for 1.5 μm transmission, in which the mode confinement is much greater than that shown in FIG. 6.

Measurements of the mode divergence were used to provide an estimate for the NA and hence the refractive index change induced by the UV laser. Mode divergence measurements in single mode waveguides at 633 nm gave numerical aperture values of order NA˜0.05 corresponding to a refractive index change of Δn˜6×10⁻⁴. However, transmission at higher order modes was observed in waveguides which were written using higher exposure levels suggesting a larger refractive index change.

Also, transmission losses were determined for a set of ten channel waveguides (exhibiting single mode transmission at 633 nm) written with a spot size of 3.25 μm at a laser fluence of 63 J/cm² and were found to be in the range of 0.2-1.5 dB/cm.

An additional loss of ˜2.5 dB was observed after 30 minutes transmission of 633 nm. This indicates the presence of the photorefractive damage at visible wavelengths in the ferroelectric material, which is direct evidence that the crystal properties have not been affected by the UV writing process.

To examine the thermal stability of the waveguides a sample was thermally annealed for 2.5 hours at 250° C. No qualitative change was observed in the waveguide mode profiles. Furthermore the waveguides are stable at room tempera and no degradation has been observed after long storage times (>6 months).

Control of Refractive Index Change

The example values quoted above for NA, Δn, scan speed, laser fluence and any other such relevant parameters are all under experimental control. Guides have been written in the surface of LiNbO₃ samples under the following (non-exhaustive) experimental conditions:

the laser power on the sample surface was between 10 and 55 mW;

the laser beam was focussed down to a spot size of order 1.7 μm (radius);

the translation speed of the sample holder was varied between 3000 mm/min and 10 mm/min;

z face crystals have been irradiated and guides have been produced; and

y face crystals have been irradiated and guides have been produced.

In all of the above cases, positive values of refractive index change have been observed.

The magnitude of the refractive index change or modification, Δn, depends in general on the amount of optical energy delivered to the sample at a particular position. This can be controlled via all or any of several parameters used in the exposure process. These parameters include the intensity of the incident optical radiation, the fluence of the incident optical radiation, the absorption depth of the optical radiation in the material and the speed of relative movement between the beam and the sample, or the duration of the exposure in non-scanning configurations. To deliver a lot of energy and hence obtain a large induced index change, one can use high intensity and fluence, a slow speed, and optical radiation having a small absorption depth in the sample material. Converse conditions will deliver less energy to give a smaller change.

The depth to which the induced change extends below the sample surface is related to the absorption depth of the optical radiation in the particular ferroelectric material of the sample, although the absorption depth in general should be small (as discussed further below with regard to wavelength) so that sufficient energy can be delivered to a given volume of material. The index change is hence confined to the surface region of the sample.

In the case of fabricating an elongate refractive index structure such as a channel waveguide by translating a focussed beam with respect to the sample surface, the width of the channel is related to the size of the focussed spot on the surface. Large spot sizes will give a wider channel. Additionally, for a given fluence and intensity, an increased exposure time (by using a slower translation speed in a scanning configuration) will also give a wider channel, in addition to a greater index change. It is expected, however, that there is a saturation point at which the widest channel and largest change can be obtained for a given set of operating parameters.

Thus, it is possible to fabricate a complex waveguide network with varying channel size and strength (size of index change) in a single writing step, by altering the intensity, fluence, and translation speed during the writing process. This can all be under computer control for a full automated process. The ability to vary channel width simply by changing the translation speed provides an attractive way of writing tapered channel waveguides.

Wavelength

The experimental evidence presented above was obtained using UV optical radiation with a wavelength of 244 nm. However, the invention is not limited thereto. It is preferable that the radiation be absorbed in a thin near surface layer (hence the induced index modification being a surface effect), so the wavelength required will depend on the ferroelectric material used. Wavelengths that undergo strong absorptions in the material in question should preferably be selected. Hence the use of UV light at 244 nm with LiNbO₃, which is reckoned to be absorbed within the first micrometer depth of material, so that the absorption depth is sub-micron. Other wavelengths in the near UV, and/or within the bandgap of LiNbO₃ and/or near the band edge of LiNbO₃ may also be useful for this material.

Further considering LiNbO₃, if visible wavelengths are used, there will be little if any absorption, the crystal will merely transmit the light, and no refractive index change is likely to be induced. However, visible light in the 450-525 nm range has successfully been used to induce an index change in Fe:doped LINbO₃, because Fe doping increases the absorption in this part of the spectrum. Therefore, various dopants may be added to various ferroelectrics to increase absorption at different wavelengths, so that a wide range of wavelengths are potentially of use in the present invention.

Ferroelectric Materials

Using the present invention, waveguides have been produced on both z face and y face LiNbO₃. It is fully expected that x face crystals will also produce effective guided wave structures.

Also, the invention is not limited to the use of LiNbO₃. Other ferroelectric hosts, such as lithium tantalate, KTiOPO₄, RTiOAsO₄, RTiOPO₄, BaTiO₃, KNbO₃, or any other suitable mixed solid solution host such as the SrₓBa₁₋ₓNbO₃ family of tungsten bronze crystals can be engineered in this fashion.

As mentioned in the previous section, the ferroelectric material may be doped with a material that increases the absorption of optical radiation of particular wavelengths. Doping is not restricted to this application, however. The ferroelectric host may be doped to include elements such as Zn and Mg in the form of ZnO or MgO, which are introduced to reduce or ideally remove photorefractive damage. Ferroelectric materials are prone to photorefractive damage, so it desirable to avoid this if possible both during fabrication of a refractive index structure and during subsequent use of that structure.

Also, the ferroelectric host may be doped with atoms or ions to assist lasing or for use as amplifiers, such elements to include rare earths, lanthanides and transition metals. Waveguides for use as lasers or for amplification of optical signals may hence be fabricated, with the active dopant being selected for action at a desired wavelength that can be guided by the waveguide.

The ferroelectric material can be in a single domain or multi-domain state prior to exposure to the irradiating light source. The sample may be a bulk crystal, although the single-step, non-contact nature of embodiments of the invention make it particularly suitable for use with fragile structures such as cantilevers and membranes.

Further, the ferroelectric material can be in the form of periodically poled material, for which the writing of a waveguide would permit subsequent highly efficient non-linear interactions via the process of quasi-phase-matching of optical signals being propagated by the waveguide.

Also, the sample may comprise a pre-existing refractive index structure, fabricated by the present invention or otherwise. Embodiments of the invention allow simple and straightforward modification (“trimming”) of the pre-existing structure, if a suitable pattern of light exposure is directed onto the sample to reshape the region of index change.

Applications

The direct write technique described thus far has immediate application to the fabrication of a wide range of waveguide devices, through the controlled manipulation of the local refractive index. The present invention simplifies significantly the procedure for fabricating refractive index structures in ferroelectrics, such as channel waveguide fabrication in lithium niobate for a wide range of integrated optical applications. Features of embodiments of the invention that position this technique as being superior to existing waveguide fabrication methods for ferroelectrics include:

no requirement for photolithography, metal deposition, high temperature diffusion processes or other multi-step procedures;

no need for high grade cleanroom environment;

precise mode control and refractive index trimming;

waveguide fabrication even on fragile structures such as lithium niobate cantilevers and membranes; and

the process is fast and takes about the 1/100 the time for waveguide fabrication compared with conventional techniques;

In consideration of the above direct benefits, the following non-exhaustive list of applications is given:

1. Fabrication of planar waveguide layers.

2. Fabrication of channel waveguide structures.

3. Refractive index trimming in existing structures fabricated by other means.

4. Low loss optical waveguides.

5. Fabrication of structures that require guides of arbitrary curvature, owing to the freedom of movement between the sample and light beam in some embodiments.

6. Fabrication of guides that have junctions.

7. Fabrication of waveguide beam splitters.

8. Fabrication of optical couplers.

9. Fabrication of multiple guides in adjacent proximity.

10. Fabrication of tapered or variable width guides.

11. Fabrication of buried guides.

12. Fabrication of single mode guides.

13. Fabrication of multimode guides.

14. Fabrication of waveguides with gratings.

15. Fabrication of complex optical devices comprising a plurality of the above features, in a single step.

Physical Effect

Investigation is ongoing to identify the precise nature of the effect by which refractive index modification is induced in ferroelectrics by exposure to optical radiation. Preliminary results suggest that laser-induced local ion out- or inter-diffusion may be responsible for the observed refractive index change; relevant ions diffuse sideways away from the exposed volume of material. Lithium out-diffusion in LiNbO₃ occurs at elevated temperatures and can induce an increase of the extraordinary index of refraction. In the present case the strong absorption of UV radiation within a small volume near the surface of LiNbO₃ can cause a local increase of the temperature which could induce out-diffusion and/or inter-diffusion of lithium which subsequently will increase the extraordinary refractive index. Using Sellmeier equations for LiNbO₃, it has been calculated that a 0.1% reduction of lithium content will produce a positive refractive index change of order 6×10⁻⁴. This is the same magnitude of change as that observed experimentally.

### CONCLUSION

A new method for direct writing of surface or near-surface modified refractive index structures in ferroelectric hosts has been described. The advantages over conventional multi-step processes in terms of speed, cost, equipment required, versatility and controllability have been described, and are considered to represent a distinct advantage over prior art techniques.

### REFERENCES

[1] E L Wooten et al, IEEE J. Select Top. in Quant. Electr. 6, 69 (2000).
[2] R V Schmidt, I P Kaminow, IEEE J. Quant Electr., 57 (1975).
[3] P E Britton, H L Offerhaus, D J Richardson, P G R Smith, G W Ross, D C Hanna, Opt Lett. 24, 975 (1999).
[4] R V Schmidt, I P Kaminov, Appi. Phys. Letts., 25, 458 (1974).
[5] J L Jackel, C E Rice, J J Veseka, Appl. Phys Letts., 41, 607 (1982)

1. A method of inducing a surface refractive index modification in ferroelectric material, comprising:
providing a sample of ferroelectric material;
determining a desired pattern of surface refractive index modification to be induced in the sample; and
exposing an area of the sample corresponding to the desired pattern to optical radiation to deliver a quantity of optical energy sufficient to induce a permanent surface refractive index modification in the exposed area of the sample.

2. A method according to claim 1, in which the quantity of optical energy is selected to induce a surface refractive index modification of a desired magnitude.

3. A method according to claim 2, in which the quantity of optical energy is determined by controlling one or more of intensity of the optical radiation, fluence of the optical radiation, duration of exposing the area of the sample, and absorption depth of the optical radiation in the sample.

4. A method according to claim 1, in which the optical radiation has a sub-micron absorption depth in the sample.

5. A method according to claim 1, in which the optical radiation is of an ultraviolet wavelength.

6. A method according to claim 1, in which the optical radiation is of a visible wavelength.

7. A method according to claim 1, in which the exposing an area of the sample comprises directing a focussed beam of optical radiation onto the sample.

8. A method according to claim 7, in which the exposing an area of the sample further comprises causing relative movement between the sample and the beam of optical radiation.

9. A method according to claim 8, in which the relative movement is of a constant speed.

10. A method according to claim 8, in which the relative movement is of a varying speed.

11. A method according to claim 7, in which the beam of optical radiation contains fringes of high and low intensity to induce a refractive index modification having the form of an optical grating.

12. A method according to claim 1, in which the exposing an area of the sample comprises projecting the optical radiation through a mask and onto the sample.

13. A method according to claim 12, in which the mask includes one or more regions configured to project fringes of high and low intensity optical radiation onto the sample to induce a refractive index modification having the form of an optical grating.

14. A method according to claim 1, in which the desired pattern of surface refractive index modification comprises a line so that the induced permanent refractive index modification comprises a channel waveguide.

15. A method according to claim 1, in which the desired pattern of surface refractive index modification comprises a network of lines so that the induced permanent refractive index modification comprises a network of channel waveguides.

16. A method according to claim 1, in which the desired pattern of surface refractive index modification comprises a continuous region so that the induced permanent refractive index modification comprises a planar waveguide.

17. A method according to claim 1, in which the sample of ferroelectric material comprises one or more dopants.

18. A method according to claim 17, in which the one or more dopants comprise optically active ions that allow a waveguide formed in the sample to exhibit laser or amplifying action.

19. A method according to claim 17, in which the one or more dopants increase absorption of the optical radiation by the sample.

20. A method according to claim 17, in which the one or more dopants reduces susceptibility of the sample to photorefractive damage caused by exposure to the optical radiation.

21. A method according to claim 1, in which the sample of ferroelectric material has a domain-engineered structure.

22. A method according to claim 21, in which the sample is periodically poled.

23. A method according to claim 1, in which the sample comprises a pre-existing structure of altered refractive index, and the desired pattern of surface refractive index modification is determined to modify the pre-existing structure.
